(19) United States
(12) Patent Application Publication
(10) Pub. No.: US 2021/0207743 A1
(43) Pub. Date: Jul. 8, 2021

(54) Securing Member For Supporting Pump Installation

(71) Applicant: Gradeway Inc., Chattaroy, WA (US)

(72) Inventor: Paul Dollfe, Chattaroy, WA (US)

(73) Assignee: Gradeway Inc., Chattaroy, WA (US)

(21) Appl. No.: 16/734,189

(22) Filed: Jan. 3, 2020

(51) Int. Cl. F16L 3/12; F16L 3/227

(52) U.S. Cl. CPC F16L 3/12; F16L 3/227

(57) ABSTRACT

A securing member includes a supporting portion configured to be fastened to a structure, and a protruding portion protruding substantially perpendicularly relative to the supporting portion. The supporting portion includes apertures through which fasteners enter in order to fasten the supporting portion to a structure. The protruding portion includes curved recesses that are configured to receive pipes such that each curved recess curves at least partially around a lateral portion of a pipe, and apertures disposed adjacent to these recesses are configured to receive fasteners that fasten the protruding portion to ends of pipes. These fasteners are also configured to fasten the ends of pipes to the openings of various pumps. The securing members, fastened in this manner, improve the operational life of pipes and pumps in an pump installation system and reduce the likelihood of deformation, strain, and misalignment.

### BACKGROUND

Conventional pump installation systems include pumps that are connected to pipes in, e.g., vertical configurations. For example, a set of pipes may exit openings in the floor, extend upwards, and connect to various openings of pumps, and another set of pipes may exit openings in the ceiling, extend downwards, and connect to opposing openings of these pumps. In such a configuration, these pipes and their connections with the pumps may suffer from deformation and deterioration due to bearing a load of the pumps, e.g., due to the operation of the pumps or due to a weight of the pumps. The pipes that extend upwards from openings in the floor may also suffer from deformation and deterioration as a result of having to bear some load of the system, such as at least a portion of the load due to the operation of the pumps or the combined weight of the pumps and the pipes which extend downwards from the ceiling.

Some of these complications can be mitigated by ensuring that all connections between the pumps and the pipes are aligned. While ensuring alignment of the connections can reduce some of these complications, it nevertheless fails to alleviate them altogether, and excessive loads borne by the pumps and certain pipes during operation can nevertheless impact their structural integrity negatively.

### SUMMARY

A securing member for supporting the installation of pumps is described. In one implementation, a securing member includes a supporting portion configured to be fastened to a structure, and a protruding that extends substantially perpendicularly relative to the supporting portion. The supporting portion is fastened to a structure via fasteners that enter apertures included in the supporting portion and entrench in the structure. The protruding portion includes curved recesses and apertures that are disposed adjacent to these recesses. The recesses are configured to receive pipes such that each recess curves at least partially around a lateral portion of a respective pipe, and the apertures are configured to receive fasteners that fasten the protruding portion to ends of the pipes. These fasteners are also configured to fasten the ends of the pipes to openings of respective pumps. The fastening may be performed using fasteners that include, e.g., a bolt, a nut configured to be coupled with a bolt, etc. The bolts may be placed such that each bolt enters an aperture of the protruding portion, an aperture located on a connective portion disposed at an end of a pipe, and another aperture located on a connective portion disposed at an opening of a pump. Thereafter, a nut may be tightened on each bolt to secure the bolt in place. In this way, the fastener (e.g., the bolt) connects the protruding portion, the end of the pipe, and the pump opening.

The recesses of the securing member described herein may have a semicircular shape, which enables these recesses to effectively curve at least partially around the lateral portions of pipes. In one implementation, the semicircular recesses may have equal dimensions, e.g., equal diameters. Alternately, the semicircular recesses of a particular securing member may have different dimensions, e.g., different diameters.

In one implementation of a pump installation system, multiple securing members may be used to support multiple pumps that are connected to pipes in a vertical configuration. For example, one securing member may be fastened to a structure such that the supporting portion of the securing member is parallel to the structure. In addition, a protruding portion of the securing member may protrude perpendicularly relative to the supporting portion. In this way, the securing member, as fastened to the structure, has an “L” shaped orientation with the base of the “L” protruding from the structure. In this orientation, the recesses of the protruding portion of the securing member may receive pipes that extend downwards, and connect to various openings of pumps. The apertures adjacent to the recesses may receive fasteners that fasten these pipes to the protruding portion and also fasten the ends of these pipes with the openings of these pumps. By being fastened to the structure, the securing member effectively bears at least a portion of a load of pipes that extend downwards and connect to the pumps rather than the pumps bearing this load. This is based on the securing member's attachment to the structure. Moreover, the shape and location of this member reduces the adverse effects on the pipes and pumps that, in conventional pump installation systems, bore the majority of the load themselves.

Additionally or alternatively, the pump installation system may include an additional securing member fastened to the structure in an additional location. Here, the supporting portion of the securing member is disposed in a position that is parallel to the structure, and the protruding portion protrudes perpendicularly relative to the supporting portion. In such implementations, this securing member may be fastened to the structure so that the member has an inverted L-shaped orientation. The recesses in the protruding portion of this securing member may receive pipes that extend upwards and connect to various opposing openings of pumps. The apertures adjacent to the recesses may receive additional fasteners that fasten upward extending pipes to the protruding portion of the additional securing member and also fasten the ends of these pipes with opposing openings of respective pumps. This additional securing member also bears at least a portion of the load of the pumps and of the pipes that extend downwards (e.g., operational, live load and dead load) based on the additional securing member's attachment to the structure.

### BRIEF DESCRIPTION OF THE DRAWINGS

FIG. 1 depicts an example implementation of a conventional pump installation system.

FIG. 2 depicts an example implementation of a pump installation system in which multiple securing members are used in multiple locations to support the installation of pumps and address the complications of conventional pump installation systems.

FIG. 3 depicts an example implementation of a pump installation system in which a securing member is fastened to a structure so that the securing member has an L-shaped orientation.

FIG. 4 depicts an example implementation of a pump installation system in which a securing member is fastened to a structure so that the securing member has an inverted L-shaped orientation.

FIG. 5 depicts an example design of the securing members depicted in FIGS. 2-4.

FIG. 6 depicts an example of a dual recessed securing member with two recesses having different dimensions.

FIG. 7 depicts an example of a single recessed securing member.

### DETAILED DESCRIPTION

### Example Securing Members Supporting Various Pump Installation Systems

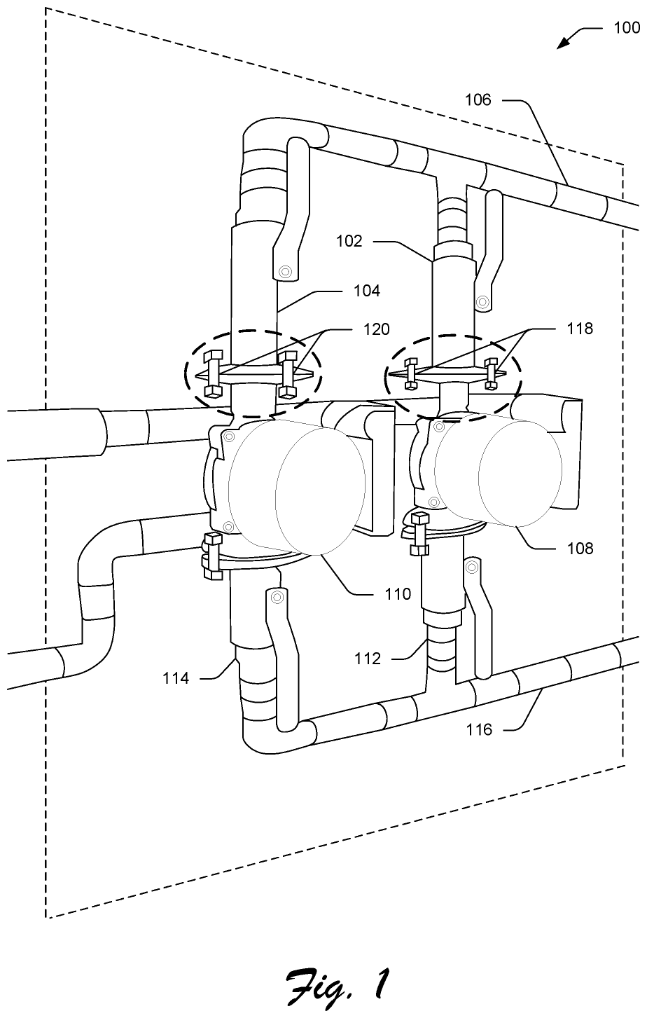

FIG. 1 depicts an example implementation of a conventional pump installation system. In the conventional pump installation system 100, pipes 102 and 104, which extend downwards from main pipe 106, connect to pumps 108 and 110, respectively. In particular, ends of the pipes 102 and 104 are connected to openings of the pumps 108 and 110 using fasteners 118 and 120, e.g., a bolt, a nut configured to be coupled with a bolt, etc. Likewise, pipes 112 and 114 extend upwards from primary pipe 116 and connect directly with opposing openings of the pumps 108 and 110, respectively. In this conventional pump installation 100, the pumps 108 and 110 bear a load of the pipes 104 and 106. Moreover, the pipes 112 and 114, which extend upwards from the primary pipe 116, bear some load of the system 100, such as at least a portion of the load due to the operation of the pumps or due to the combined weight of the pumps 108 and 110, and the pipes 102 and 104 which extend downwards from the main pipe 106.

Consequently, the pumps 106 and 108 experience a variety of effects that negatively impact their structural integrity. The pumps suffer, for example, from pump deformation, pump imbalance, deterioration of pump casing, and pump misalignment, all of which reduce the operational life of these pumps. These pumps are also susceptible to damage caused by vibrations due to, e.g., the operations of the pumps, the operation of machinery located near the pump installation 100, etc. Such vibrations damage the fasteners used to connect the pipes with the pumps in the installation, thereby accelerating pump deformation, and increasing the likelihood of pump misalignment. The conventional pump installation in FIG. 1 also adversely affects the operational life of the pipes 102, 104, 112 and 114. Pipes 112 and 114 suffer from deformation, strain, and misalignment because of bearing the load of the pumps 108 and 110, e.g., due to the operation of the pumps or as a result of the combined weight of the pumps 108 and 110 and the pipes 102 and 104 that extend downwards. Moreover, any vibrations experienced by the pump installation system accelerates one or more of the adverse effects suffered by the pipes 108, 110, 112, and 114.

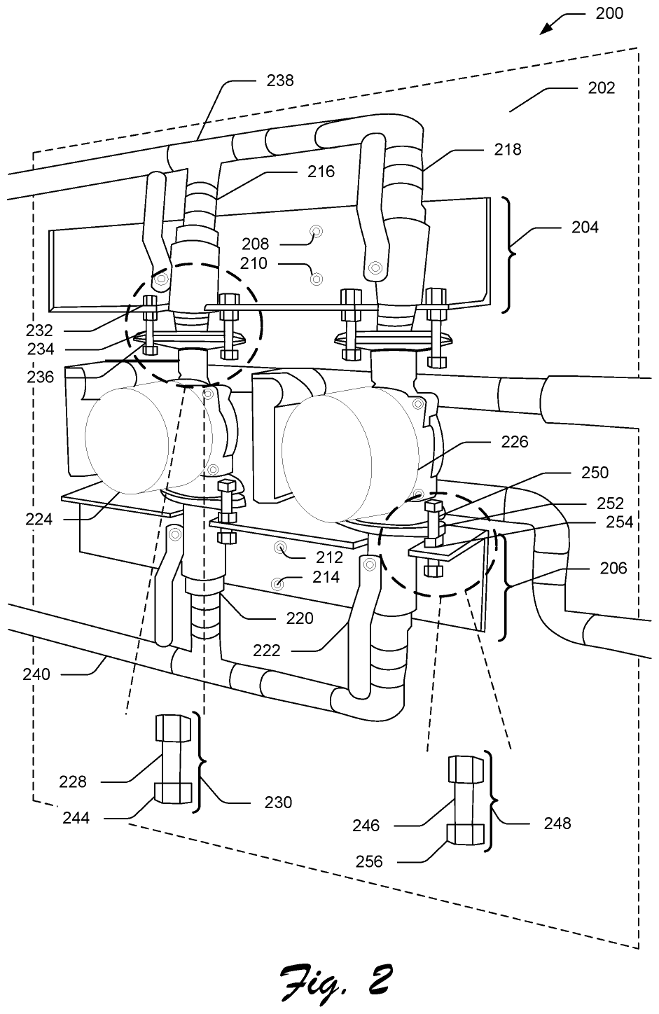

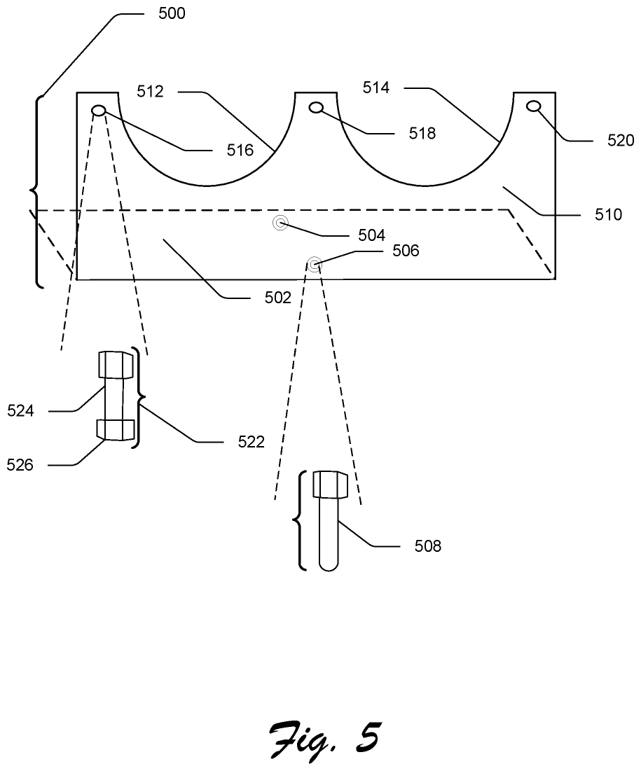

FIG. 2 depicts an example implementation of a pump installation system in which multiple securing members are used in multiple locations to support the installation of pumps and address the complications of conventional pump installation systems. The pump installation system 200 in FIG. 2 includes a structure 202 to which an upper securing member 204 and a lower securing member 206 are fastened. However, before describing the shape and locations of the securing members depicted in system 200, a description of an example design of these securing members, shown in FIG. 5, is instructive.

FIG. 5 depicts an example design of the securing members. The example securing member 500 includes a supporting portion 502 configured to be fastened to a structure (not shown). Specifically, the supporting portion 502 includes apertures 504 and 506 configured to receive fasteners that may be used to fasten the supporting portion to a structure, e.g., a wall, a beam etc. In one example, these fasteners may be bolts that enter apertures 504 and 506 and entrench in the structure. An example of one of these bolts is bolt 508, depicted in FIG. 5. The example securing member 500 also includes a protruding portion 510 that protrudes substantially perpendicularly relative to the supporting portion 502. In one example, the protruding portion 510 includes curved recesses 512 and 514 having the same dimensions, e.g., diameters measuring three and a half inches. Alternatively, curved recesses having other dimensions are also contemplated. Additionally, while the curved recesses 512 and 514 have a semicircular shape, other shapes are also contemplated, e.g., a partially rectangular or partially square shape. The curved recesses 512 and 514 are configured to receive pipes such that each curved recess curves at least partially around a lateral portion of a pipe.

The protruding portion 510 also includes the apertures, 516, 518, and 520 disposed adjacent to the curved recesses 512 and 514. These apertures are configured to receive fasteners to fasten ends of pipes to the protruding portion 510, in addition to fastening the ends of the pipes to openings of pumps. In FIG. 5, another example fastener 522 is depicted, which includes a nut 526 that is configured to be coupled with a bolt 524. In one example, the bolt 524 may be placed in a pump installation such that the bolt may enter an aperture 516 of the protruding portion, an aperture located on a connective portion disposed at an end of a pipe, and another aperture located on a connective portion disposed at an opening of a pump. After such placement, one end of the bolt may extend beyond the protruding portion 510 in a vertical direction and the other end of the bolt may extend beyond the connective portion the pump opening in another vertical direction. A nut 526 may be tightened on the bolt 524 to secure the bolt in place. In this way, the fastener 522 may effectively connect the protruding portion 510 of the securing member 500 with the end of the pipe, and the end of the pipe with the pump opening. The securing member 500 may be made of a uniform material or a combination of different materials, e.g., metal, alloys, etc.

Returning to FIG. 2, the pump installation system 200 depicted herein includes the upper securing member 204 and the lower securing member 206 installed in select locations to effectively support the installation of multiple pumps. In FIG. 2, the upper securing member 204 and the lower securing member 206 are fastened to the structure 202, e.g., a wall. In particular, the upper and lower securing members 204 and 206 are fastened to the structure 202 using fasteners that enter apertures 208, 210, 212, and 214, respectively, and are subsequently entrenched in the structure 202. The upper securing member 204 also has a protruding portion with two curved recesses (not shown), each of which is configured to receive a lateral portion of pipe 216 and a lateral portion of pipe 218, respectively. The lower securing member 206 also has a protruding portion with two curved recesses (not shown), each of which is configured to receive a lateral portion of pipe 220 and a lateral portion of pipe 222, respectively.

In addition, the protruding portion of the upper securing member 204 also includes apertures through which fasteners enter to fasten an end of the pipe 216 with an opening of pump 224, and an end of the pipe 218 with an opening of pump 226. The connection of the pipe 216 to the pump 224 is indicated using dotted lines. As shown, a bolt 228 of a fastener 230 enters an aperture 232 located on the protruding portion of the upper securing member 204, a pipe aperture 234 located on a connective portion disposed at an end of the pipe 216, and a pump aperture 236 located on a connective portion disposed at an opening of the pump 224. An end of the bolt 228 extends vertically beyond the protruding portion of the upper securing member 204 in the direction of main pipe 238, and the other end of the bolt 228 extends beyond the connective portion disposed at the opening of the pump 224 in the direction of primary pipe 240. Thereafter, a nut 244 may be tightened on the bolt 228 to secure the bolt in place. In this way, the fastener 230 may be placed to effectively connect the protruding portion of the upper securing member 204 with the end of the pipe 216, which in turn is connected to the opening of pump 224. The pipe 218 is connected to the pump 226 in a manner similar.

Likewise, the protruding portion of the lower securing member 206 includes apertures through which fasteners enter in order to fasten an end of the pipe 220 with an opposing opening of the pump 224 and an end of the pipe 222 with an opposing opening of the pump 226. The connection of the pipe 222 to the pump 226 is indicated using dotted lines. As shown, a bolt 246 of fastener 248 enters a pump aperture 250 located on a connective portion disposed at the opposing opening of the pump 226, a pipe aperture 252 located on a connective portion disposed at the end of the pipe 222, and an aperture 254 located on the protruding portion of the lower securing member 206. An end of the bolt 246 extends vertically beyond the connective portion disposed at the opposing opening of the pump 226 in the direction of the main pipe 238 and the other end of the same bolt extends beyond the protruding portion of the securing member 206 in the direction of the primary pipe 240. Thereafter, a nut 256 may be tightened on the bolt 246 to secure the bolt in place. In this way, the bolt 246 connects the protruding portion of the lower securing member 206 to the end of pipe 222, which in turn is connected to the opening of pump 226. The pipe 220 is connected to the pump 224 in a similar manner.

The shape and location of the upper securing member 204 provides support and stability to the pumps 224 and 226 and reduces various adverse effects on these pumps and on pipes 216, 218, 220, and 222. The upper securing member 204 is fastened to the structure 202 such that the supporting portion of the securing member is parallel to the structure. In addition, a protruding portion of the upper securing member 204 may protrude perpendicularly relative to the supporting portion such that the upper securing member 204 has a particular orientation. Specifically, the upper securing member 204, as fastened to the structure 202, has an “L” shaped orientation with the base of the “L” protruding from the structure 202. This shape and the location of the upper securing member 204 enables the member to effectively bear at least a portion of a load of the pipes 216 and 218 that extend downwards and connect to the pumps 224 and 226 rather than the pumps bearing this load themselves. This is based on the attachment of the upper securing member 204 to the structure 202. The upper securing member 204, as installed, also reduces the adverse effects of vibrations on the pumps 224 and 226, and pipes 216, 218, 220, and 222 by maintaining the pumps 224 and 226 in substantially immobilized positions. These vibrations may be due to, e.g., the operations of the pumps, the operation of machinery located near the pump installation 200, etc.

In addition, the shape and location of the lower securing member 206 also provides support and stability to the pumps 224 and 226 and reduces various adverse effects on these pumps and on pipes 216, 218, 220, and 222. The lower securing member 206 is fastened to the structure 202 such that the supporting portion of the securing member is parallel to the structure 202. In addition, a protruding portion of the lower securing member 206 may protrude perpendicularly relative to the supporting portion such that the lower securing member 206 has a particular orientation. Specifically, the lower securing member 206, as fastened to the structure 202, has an inverted “L” shaped orientation with the base of the inverted “L” protruding from the structure 202. Such a shape and location enables the lower securing member 206 to bear at least a portion of the load of the pipes 216 and 218 the pumps 224 and 226 (e.g., operational, live load, and dead load) based on the attachment of the lower securing member 206 to the structure 202. The lower securing member 206, as installed, also reduces the adverse effects of vibrations on the pumps 224 and 226, and pipes 216, 218, 220, and 222 by maintaining the pumps 224 and 226 in substantially immobilized positions. As stated, these vibrations may be due to, e.g., operations of the pumps, operation of machinery located near the pump installation 200, etc. While the pump installation system depicts use of multiple securing members in varying orientations, fastening one or more securing members in one orientation are also contemplated.

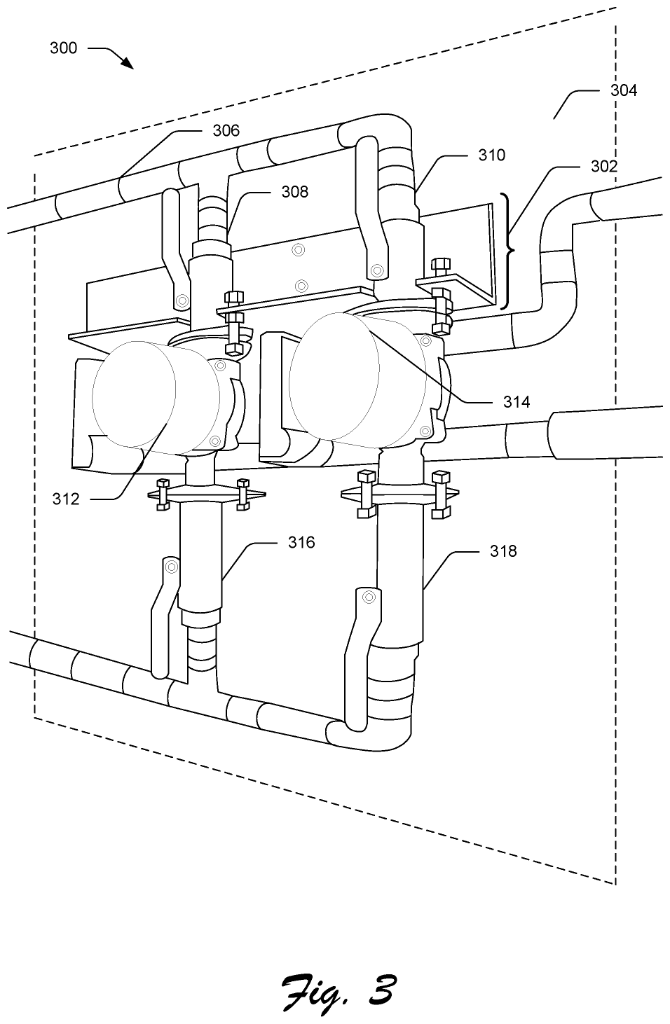

FIG. 3 depicts an example implementation of a pump installation system in which a securing member is fastened to a structure so that the securing member has an L-shaped orientation. In particular, in a pump installation system 300, an example upper securing member 302 is fastened to an upper portion of a structure 304 (e.g., a wall) such that the supporting portion of the member is parallel to the structure 304, and the protruding portion protrudes perpendicularly relative to the supporting portion such that the example upper securing member 304 has an “L” shaped orientation. This shape and location of the member (i.e. on the upper portion of the structure 304) enables the member to effectively bear at least a portion of a load of pipes 308 and 310 on the pumps 312 and 314. Moreover, the shape and location of this member reduces the adverse effects on the pipes and pumps that, in conventional systems, bore the majority of the load themselves. The example upper securing member 304 also reduces the adverse effective of vibrations on these pumps and pipes by maintaining the pumps 312 and 314 in substantially immobilized positions. Fastening the example securing member 302 as depicted in FIG. 3 may be effective in pump installation systems that, e.g., have space constraints.

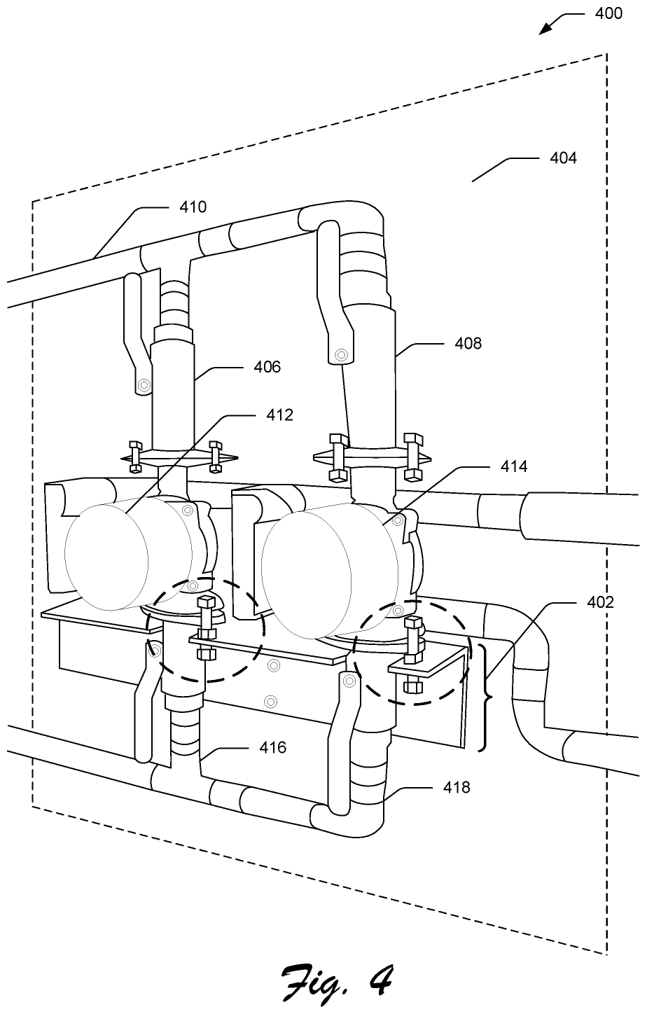

FIG. 4 depicts an example implementation of a pump installation system in which a securing member is fastened to a structure so that the securing member has an inverted L-shaped orientation. In the pump installation system 400, an example lower securing member 402 is fastened to a lower portion of a structure 404 (e.g., a wall) such that the supporting portion of the member is parallel to the structure 404, and the protruding portion protrudes perpendicularly relative to the supporting portion such that the example lower securing member 402 has an inverted “L” shaped orientation. This shape and location of the member (i.e. on the lower portion of the structure 404) enables the member to bear at least a portion of the load of the pipes 406 and 408 that extend downwards and the pumps 412 and 414 based on the attachment of the example lower securing member 402 to the structure 404. The lower securing member 402, as installed, also reduces the adverse effects of vibrations on the pumps 412 and 414, and the pipes 406, 408, 416, and 418 by maintaining the pumps 412 and 414 in substantially immobilized positions. Broadly speaking, fastening the example securing member 402 as depicted in FIG. 4 may be appropriate in pump installation systems that have space constraints.

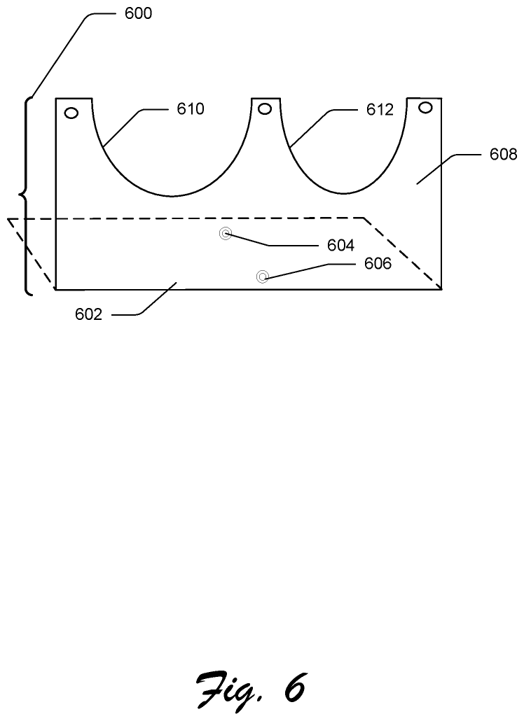

FIG. 6 depicts an example of a dual recessed securing member with two recesses having different dimensions. FIG. 6 depicts an example dual recessed securing member 600 having a supporting portion 602 that includes apertures 604 and 606. This member also has a protruding portion 608 that protrudes substantially perpendicularly relative to the supporting portion 602. The protruding portion 608 has a recess 610 having a dimension that is larger the other recess 612. Such a securing member may be effective in supporting the installation of pumps with different dimensions in adjacent locations, which facilitates the installation of pumps of various shapes and dimensions.

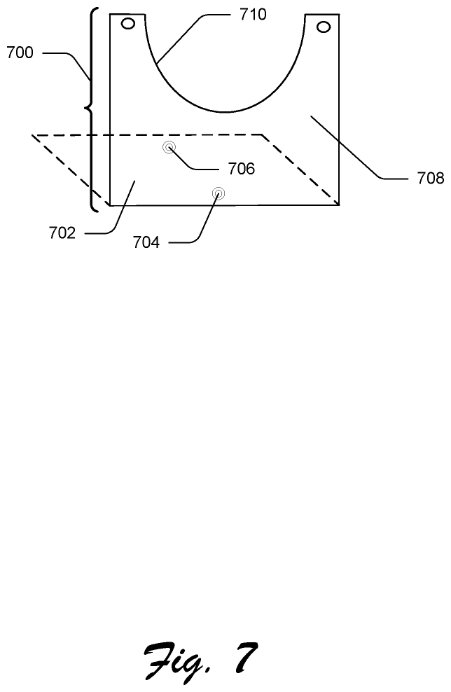

FIG. 7 depicts an example of a single recessed securing member. FIG. 7 depicts an example single recessed securing member 700 having a supporting portion 704 that includes apertures 706 and 708. This member also has a protruding portion 710 that protrudes substantially perpendicularly relative to the supporting portion 704. Broadly speaking, such a securing member may be effective in supporting installation of pumps in pump installation systems with severe space constraints.

The shape and locations of the securing members described in FIGS. 2-7 address and overcome the limitations of conventional pump installation systems. In particular, as each of the securing members described herein have a supporting portion that can be fastened to a structure (e.g., a wall) and a protruding portion that can be fastened to a pipe, which is fastened to a pump (all of which can be done using a single fastener), the securing members can effectively leverage the support and stability of structures (e.g., walls) to improve the operational life of pipes and pumps in various pump installation systems. Another benefit of fastening the securing members as described is that the damage to the fasteners is limited, and the possibility of pump misalignment is reduced, which improves pump operational life. The shapes and locations of these members improve the operational life of pipes by reducing the likelihood of deformation, strain, and misalignment.

### CONCLUSION

Although the subject matter has been described in language specific to certain devices and systems, it is to be understood that the systems and devices described in the appended claims and elsewhere in the specification of this Application are not necessarily limited just to the described systems and devices. Rather, the specific systems and devices disclosed in the appended claims and elsewhere in the specification of this Application are example forms of implementing the claimed subject matter.

What is claimed is:

1. A securing member for supporting pump installation, the securing member comprising:
a supporting portion configured to be fastened to a structure; and
a protruding portion including:
curved recesses configured to receive a plurality of pipes such that each curved recess curves at least partially around a lateral portion of a respective pipe of the plurality of pipes; and
apertures configured to receive fasteners to fasten ends of the plurality of pipes to the protruding portion, the fasteners further configured to fasten the ends of the plurality of pipes to respective openings of a plurality of pumps.

2. The securing member as described in claim 1, wherein the protruding portion is configured to bear, in part, loads of the plurality of pipes based on a fastening of the supporting portion of the securing member to the structure.

3. The securing member as described in claim 1, wherein the securing member is configured to maintain the plurality of pumps in substantially immobilized positions.

4. The securing member as described in claim 1, wherein the structure is a wall substantially parallel to the supporting portion of the securing member.

5. The securing member as described in claim 1, wherein the protruding portion protrudes substantially perpendicularly relative to the supporting portion.

6. A pump installation support system comprising:
a plurality of pumps;
a plurality of pipes;
a plurality of fasteners;
a securing member including:
a supporting portion configured to be fastened to a structure;
a protruding portion including:
curved recesses configured to receive the plurality of pipes such that each curved recess curves at least partially around a lateral portion of a respective pipe of the plurality of pipes; and
apertures configured to receive the plurality of fasteners to fasten ends of the plurality of pipes to the protruding portion, the plurality of fasteners further configured to fasten the ends of the plurality of pipes to respective openings of the plurality of pumps.

7. The system as described in claim 6, wherein the protruding portion of the securing member is configured to bear, in part, a load of the plurality of pipes based on a fastening of the supporting portion of the securing member to the structure.

8. The system as described in claim 6, wherein the securing member maintains the plurality of pumps in substantially immobilized positions.

9. The system described in claim 6, wherein the structure is a wall substantially parallel to the supporting portion of the securing member.

10. The pump installation support system 6, further comprising an additional securing member including:
a supporting portion configured to be fastened to the structure; and
a protruding portion including:
curved recesses configured to receive an additional plurality of pipes such that each curved recess curves at least partially around a lateral portion of a respective pipe of the additional plurality of pipes; and
apertures configured to receive an additional plurality of fasteners to fasten ends of the additional plurality of pipes to the protruding portion, the additional plurality of fasteners further configured to fasten the ends of the additional plurality of pipes to respective openings of an additional plurality of pumps.

11. The system as described in claim 10, wherein the protruding portion of the additional securing member is configured to bear, in part, a load of the additional plurality of pipes based on a fastening of the supporting portion of the additional securing member to the structure.

12. The system as described in claim 10, wherein the additional securing member maintains the additional plurality of pumps in substantially immobilized positions.

13. The system as describe in claim 10, wherein the protruding portion of the securing member protrudes substantially perpendicularly relative to the supporting portion of the securing member, and the protruding portion of the additional securing member protrudes substantially perpendicularly relative to the supporting portion of the additional securing member.

14. The system described in claim 10, wherein the structure is a wall substantially parallel to the supporting portion of the additional member.

15. A securing member for supporting pump installation, the securing member comprising:
a supporting portion configured to be fastened to a structure; and
a protruding portion including:
a curved recess configured to receive a pipe such that the curved recess curves at least partially around a lateral portion of the pipe; and
an aperture configured to receive a fastener to fasten an end of the pipe to the protruding portion, the fastener further configured to fasten the end of the pipe to an opening of a pump.

16. The securing member as described in claim 15, wherein the protruding portion includes:
an additional curved recess configured to receive an additional pipe such that the additional curved recess curves at least partially around a lateral portion of the additional pipe; and
an additional aperture configured to receive an additional fastener to fasten an end of the additional pipe to the protruding portion, the fastener further configured to fasten the end of the additional pipe to an opening of an additional pump.

17. The securing member as described in claim 15, wherein the protruding portion is configured to bear, in part, a load of the pipe based on a fastening of the supporting portion of the securing member to the structure.

18. The securing member as described in claim 15, wherein the securing member is configured to maintain the pump in a substantially immobilized position.

19. The securing member as described in claim 15, wherein the protruding portion protrudes substantially perpendicularly relative to the supporting portion of the securing member.

20. The securing member as described in claim 15, wherein the structure is a wall substantially parallel to the supporting portion of the securing member.
